(19) United States
(12) Patent Application Publication
(10) Pub. No.: US 2026/0008910 A1
(43) Pub. Date: Jan. 8, 2026

(54) POLYETHYLENE COPOLYMER FOR A FILM LAYER

(71) Applicant: BOREALIS AG, Vienna (AT)

(72) Inventors: Jingbo WANG, Linz (AT); Friedrich BERGER, Linz (AT); Jani AHO, Porvoo (FI)

(73) Assignee: BOREALIS AG, Vienna (AT)

(21) Appl. No.: 18/880,313

(22) PCT Filed: Jun. 29, 2023
(86) PCT No.: PCT/EP2023/067755

§ 371 Date: Dec. 31, 2024

(30) Foreign Application Priority Data
Jul. 1, 2022 (EP) 22182462.6

(51) Int. Cl. C08L 23/0807; C08F 4/659; C08F 4/6592; C08F 210/16; C08J 5/18; C08L 91/06

(52) U.S. Cl. CPC C08L 23/0815; C08F 4/65927; C08F 210/16; C08J 5/18; C08F 4/65912; C08F 4/65916; C08F 2420/07; C08J 2323/08; C08J 2423/08; C08L 91/06; C08L 2205/025; C08L 2207/06; C08L 2314/06

(57) ABSTRACT

The present disclosure relates to a metallocene-catalysed multimodal medium density polyethylene (mMDPE), inclusion of the multimodal medium density polyethylene (mMDPE) in film applications, and film including the mMDPE of the disclosure.

The present invention relates to a metallocene-catalysed multimodal medium density polyethylene (mMDPE), to the use of the multimodal medium density polyethylene (mMDPE) in film applications and to a film comprising the mMDPE of the invention.

State of the art mLLDPE (metallocene catalysed linear low density polyethylene) is widely used everywhere in daily life, like packaging, due to its excellent cost/performance ratios. Unimodal mLLDPEs are usually used for film application. Unimodal LLDPEs have for instance good optical properties, like low haze, but for instance, the melt processing of such polymers is not satisfactory in production point of view and may cause quality problems of the final product as well. Multimodal mLLDPEs with two or more different polymer components are better to process, but e.g. melt homogenisation of the multimodal PE may be problematic resulting to inhomogeneous final product evidenced e.g. with high gel content of the final product.

Multimodal mLLDPEs are known in the art.

WO 2021009189, WO 2021009190 and WO 2021009191 of Borealis disclose a process for preparing multimodal PE polymers in two loop reactors and one gas phase reactor in the presence of a silica supported metallocene catalyst based on the metallocene complex bis(1-methyl-3-n-butylcyclopentadienyl) zirconium (IV) dichloride.

Film properties, like tensile modulus (TM) and impact strength (dart drop impact, DDI) are not mentioned at all.

Also WO 2021009192 discloses such a process.

Film properties, like tensile modulus (TM) and impact strength (dart drop impact, DDI) are again not mentioned at all.

There is a continuous need to find multimodal PE polymers with different property balances for providing tailored solutions to meet the increasing demands of the end application producers e.g. for reducing the production costs while maintaining or even improving the end product properties. Tailored polymer solutions are also needed to meet the requirements of continuously developing equipment technology in the end application field.

Therefore, there is a need in the art for providing a material that provides good mechanical properties, especially tensile modulus and dart drop (impact strength).

The inventors have now found, that a metallocene catalysed medium density polyethylene (mMDPE) made with a specific metallocene catalyst and having a specific polymer design yields films having improved mechanical properties, especially tensile modulus and dart drop (impact strength). Furthermore mMDPEs with this specific design can be easily processed with the addition of a polyethylene wax as processing aid instead of commonly used fluoro-based processing aids, which are due to their fluoro content under concerns in view of Human and Environmental Health.

### DESCRIPTION OF THE INVENTION

The present invention is therefore directed to a metallocene catalysed multimodal medium density polyethylene (mMDPE) which consists of
(i) 35.0 to 55.0 wt %, based on the mMDPE, of a polyethylene component (A), and
(ii) 45.0 to 65.0 wt %, based on the mMDPE, of a polyethylene component (B),
whereby the polyethylene polymer component (A) has
   a density (ISO 1183) in the range of from 930 to 975 kg/m³,
   a MFR₂ (190° C., 2.16 kg, ISO 1133) in the range of from 10.0 to 200.0 g/10 min;
the polyethylene component (B) has
   a density (ISO 1183) in the range of from 870 to 910 kg/m³,
   a MFR₂ (190° C., 2.16 kg, ISO 1133) in the range of from 0.0001 to 0.5 g/10 min;
whereby the metallocene catalysed medium density polyethylene (mMDPE) has
   a density (ISO 1183) in the range of from 915 to 945 kg/m³,
   a MFR₂ (190° C., 2.16 kg, ISO 1133) in the range of from 0.1 to 2.0 g/10 min and
   a ratio of the MFR₂₁ (190° C., 21.6 kg, ISO 1133) to MFR₂ (190° C., 2.16 kg, ISO 1133), MFR₂₁/MFR₂, in the range of from 37 to 75 and
      wherein the difference in density of the polyethylene component (A) to the density of the final metallocene catalysed mMDPE (Δ density: density of polyethylene component (A)−density of final metallocene catalysed mMDPE) is in the range of 28 to 70 kg/m³.

In an embodiment of the present invention, the polyethylene component (A) of the metallocene catalysed multimodal medium density polyethylene (mMDPE) consists of an ethylene polymer fraction (A-1) and an ethylene polymer fraction (A-2).

In another embodiment the metallocene catalysed multimodal medium density polyethylene (mMDPE) can be blended with 0.1 to 3.0 wt %, based on the total weight of the blend, of a polyethylene wax as processing aid.

Unexpectedly such a mMDPE or the blend with a polyethylene wax provides films with improved mechanical properties, especially tensile modulus and dart drop (impact strength).

The invention is therefore further directed to a film comprising at least one layer comprising the above described mMDPE.

### Definitions

Where the term “comprising” is used in the present description and claims, it does not exclude other non-specified elements of major or minor functional importance. For the purposes of the present invention, the term “consisting of” is considered to be a preferred embodiment of the term “comprising of”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined above.

Where an indefinite or definite article is used when referring to a singular noun, e.g. “a”, “an” or “the”, this includes a plural of that noun unless something else is specifically stated.

Medium density polyethylene (MDPE) is defined in this invention as polyethylene with a density in the range of 915 to 945 kg/m³.

Metallocene catalysed medium density polyethylene (mMDPE) is defined in this invention as medium density polyethylene, which has been produced in the presence of a metallocene catalyst.

For the purpose of the present invention “medium density polyethylene (MDPE) which comprises polyethylene component (A) and polyethylene component (B)” means that the MDPE is produced in an at least 2-stage sequential polymerization process, wherein first component (A) is produced and component (B) is then produced in the presence of component (A) in a subsequent polymerization step, yielding the MDPE or vice versa, i.e. first component (B) is produced and component (A) is then produced in the presence of component (B) in a subsequent polymerization step, yielding the MDPE.

MDPEs produced in a multistage process are also designated as “in-situ” or “reactor” blends. The resulting end-product consists of an intimate mixture of the polymers from the two or more reactors, the different molecular-weight-distribution curves of these polymers together forming a molecular-weight-distribution curve having a broad maximum or two or more maxima, i.e. the end product is a multimodal polymer mixture.

Term “multimodal” in context of medium density polyethylene (MDPE) means herein multimodality with respect to melt flow rate (MFR) of the at least two polyethylene components, i.e. the two polyethylene components, have different MFR values. The multimodal medium density polyethylene can have in addition or alternatively multimodality between the two polyethylene components with respect to one or more further properties, like density, comonomer type and/or comonomer content, as will be described later below.

### DETAILED DESCRIPTION OF INVENTION

### Ad Metallocene Catalysed Multimodal Medium Density Polyethylene (mMDPE)

The metallocene catalysed multimodal mMDPE according to the present invention has a density (ISO 1183) in the range of 915 to 945 kg/m³, preferably 918 to 940 kg/m³ and more preferably 920 to 935 kg/m³.

The MFR₂ (190° C., 2.16 kg, ISO 1133) of the metallocene catalysed mMDPE is in the range of 0.1 to 2.0 g/10 min, preferably 0.2 to 1.8 g/10 min, more preferably 0.3 to 1.5 g/10 min and even more preferably 0.4 to 1.0 g/10 min.

The MFR₂₁ (190° C., 21.6 kg, ISO 1133) of the metallocene catalysed mMDPE is in the range of 10.0 to 80.0 g/10 min, preferably in a range of 15.0 to 70.0 g/10 min, more preferably in the range of 20.0 to 60.0 g/10 min and most preferably in the range of 22.0 to 50.0 g/¹⁰ min.

The metallocene catalysed mMDPE according to the present invention furthermore has a Flow Rate Ratio (FRR) of the MFR₂₁/MFR₂ in the range of 37 to 75, preferably of 40 to 70 and more preferably of 42 to 65.

In an embodiment, the metallocene catalysed mMDPE has
a) a density (ISO1183) in the range of 918 to 940 kg/m³, preferably 920 to 935 kg/m³.

In another embodiment the metallocene catalysed mMDPE has
b) a MFR₂ (190°° C., 2.16 kg, ISO 1133) in the range of 0.2 to 1.8 g/10 min, preferably 0.3 to 1.5 g/10 min and more preferably 0.4 to 1.0 g/10 min.

In yet another embodiment the metallocene catalysed mMDPE has
c) a MFR₂₁ (190° C., 21.6 kg, ISO 1133) in the range of 15.0 to 70.0 g/10 min, preferably in the range of 20.0 to 60.0 g/10 min and more preferably 22.0 to 50.0 g/10 min.

In a further embodiment the the metallocene catalysed mMDPE has
d) a Flow Rate Ratio (FRR), MFR₂₁/MFR₂ in the range of 40 to 70, preferably of 42 to 65.

Preferably, the metallocene catalysed mMDPE has two and more preferably all of the properties a)-d).

Additionally, the metallocene catalysed MDPE may have a molecular weight distribution (MWD), Mw/Mn, in the range of 3.5 to 12.0, preferably 4.0 to 10.0, and more preferably 4.2 to 8.0

In addition, the metallocene catalysed mMDPE according to the present invention may have one or more or all of the properties described now below:

### Weight Average Molecular Weight Mw

The metallocene catalysed mMDPE may have a weight average molecular weight, Mw, of at least 90000 g/mol, preferably in the range of 92000 to 140000 g/mol, more preferably 95000 to 130000 g/mol, still more preferably 100000 to 120000 g/mol.

### z Average Molecular Weight Mz

The z average molecular weight, Mz, may be in the range of 200000 to 500000 g/mol, preferably 230000 to 400000 g/mol and more preferably from 250000 to 350000 g/mol.

### Ratio of Mz/Mw

The ratio of Mz/Mw may be in the range of 2.0 to 4.0, preferably 2.2 to 3.5 and more preferably 2.3 to 3.2.

The metallocene catalysed mMDPE consists of
(i) 35.0 to 55.0 wt %, preferably 38.0 to 52.0 wt %, more preferably 40.0 to 50.0 wt %, relative to the total weight of the mMDPE, of an polyethylene component (A) with a density in the range of 930 to 975 kg/m³ and a MFR₂ (190° C., 2.16 kg, ISO 1133) of 10.0 to 200 g/10 min; and
(ii) 45.0 to 65.0 wt %, preferably 48.0 to 62.0 wt %, more preferably 50.0 to 60.0 wt %, relative to the total weight of the mMDPE, of an polyethylene component (B) with a density in the range of 870 to 910 kg/m³ and a MFR₂ (190° C., 2.16 kg, ISO 1133) of 0.0001 to 0.5 g/10 min. The amounts of components (A) and (B) sum up to 100 wt %.

The difference in density of the polyethylene component (A) to the density of the final metallocene catalysed mMDPE (Δ density: density of polyethylene component (A)—density of final metallocene catalysed mMDPE) in the range of 28 to 70 kg/m³, preferably 30 to 55 kg/m³ and more preferably 32 to 45 kg/m³.

The polyethylene component (A) and/or (B) can be a homopolymer or an ethylene copolymer.

Preferably, the mMDPE can have two copolymer components or one copolymer component and one homopolymer component, thus preferably both components are an ethylene copolymer or alternatively polyethylene component (A) is a homopolymer and polyethylene component (B) is a copolymer or vice versa (polyethylene component (A) being a copolymer and polyethylene component (B) being a homopolymer).

In one preferred embodiment polyethylene component (A) is a copolymer and polyethylene component (B) is a copolymer.

In another preferred embodiment polyethylene component (A) is a copolymer and polyethylene component (B) is a homopolymer.

Preferred ethylene copolymers employ alpha-olefins (e.g. C3-12 alpha-olefins) as comonomers. Examples of suitable alpha-olefins include 1-butene, 1-hexene and 1-octene. 1-butene and 1-hexene are especially preferred comonomers.

In view of the present invention by polyethylene homopolymer a polymer is meant, which comprising at least 99.0 wt %, especially at least 99.5 wt % ethylene monomer units. Thus, the polyethylene homopolymer may comprise up to 1.0 wt % comonomer units, but preferably comprises only up to 0.5 wt %, like up to 0.2 wt % or even up to 0.1 wt % only.

In an embodiment of the present invention, the amount of comonomer in the polyethylene homopolymer component is not detectable with ¹³C-NMR.

Preferably, polyethylene component (B) consists of a single ethylene copolymer or of a single ethylene homopolymer. Polyethylene component (A) may consist of a single ethylene homo- or copolymer. Alternatively, polyethylene component (A) may be an ethylene polymer mixture comprising (e.g. consisting of) a first ethylene polymer fraction (A-1) and a second ethylene polymer fraction (A-2), whereby both fractions are either a homopolymer or a copolymer. Polyethylene component (A) may be unimodal or multimodal. In case polyethylene component (A) is an ethylene copolymer mixture, it is preferable if the comonomer(s) in the first and second ethylene copolymer fractions are the same.

Most preferably, the polyethylene component (A) is an ethylene-1-butene copolymer and the polyethylene component (B) is either an ethylene-1-hexene copolymer or an ethylene homopolymer.

The polyethylene component (A) preferably has a MFR₂ in the range of 15.0 to 150 g/10 min, more preferably 20.0 to 100 g/10 min, even more preferably 22.0 to 90.0 g/10 min and most preferably 25.0 to 80.0 g/10 min.

The density of polyethylene component (A) preferably is in the range of 935 to 972 kg/m³, more preferably 940 to 970 kg/m³, even more preferably 945 to 968 kg/m³, yet more preferably 950 to 968 kg/m³ and most preferably 955 to 968 kg/m³, like 960 to 968 kg/m³.

It is further preferred that polyethylene component (A) consists of two fractions, i.e. a first ethylene polymer fraction (A-1) and a second ethylene polymer fraction (A-2), preferably a first ethylene copolymer fraction (A-1) and a second ethylene copolymer fraction (A-2). More preferably both fractions (A-1) and (A-2) are ethylene-1-butene copolymers.

It is possible that fraction (A-1) is produced first and then fraction (A-2) is produced in the presence of fraction (A-1) in a subsequent reactor or vice versa, i.e. fraction (A-2) is produced first and then fraction (A-1) is produced in the presence of fraction (A-2) in a subsequent reactor. Preferably, fraction (A-1) is produced first.

The MFR₂ and/or the density of fractions (A-1) and (A-2) may be the same or may be different from each other.

Thus, the ethylene polymer fraction (A-1) preferably has a MFR₂ (190° C., 2.16 kg, ISO 1133) in the range of 3.0 to 80.0 g/10 min, preferably of 5.0 to 60.0 g/10 min, more preferably of 8.0 to 40.0 g/10 min and even more preferably of 10.0 to 30.0 g/10 min.

The ethylene polymer fraction (A-2) preferably has a MFR₂ (190° C., 2.16 kg, ISO 1133) in the range of 10.0 to 1000 g/10 min, preferably of 20.0 to 800.0 g/10 min, more preferably of 30.0 to 700.0 g/10 min and most preferably of 35.0 to 600.0 g/10 min, like 40.0 to 500 g/10 min.

Preferably, the MFR₂ of fraction (A-2) is higher than the MFR₂ of fraction (A-1).

The density of the ethylene polymer fraction (A-1) preferably is in the range of 930 to 970 kg/m³, more preferably 940 to 965 kg/m³ and even more preferably 950 to 960 kg/m³.

The ethylene polymer fraction (A-2) preferably has a density in the range of 930 to 980 kg/m³, more preferably 940 to 980 kg/m³ and even more preferably 950 to 979 kg/m³.

Preferably, the density of fraction (A-2) is higher than the density of fraction (A-1).

The polyethylene component (B) preferably has a MFR₂ in the range of 0.001 to 0.1 g/10 min, more preferably 0.003 to 0.08 g/10 min, and even more preferably 0.005 to 0.05 g/10 min.

The density of the polyethylene component (B) preferably is in the range of 875 to 908 kg/m³, more preferably 880 to 906 kg/m³ and even more preferably 885 to 904 kg/m³.

In an embodiment of the present invention, the metallocene catalysed mMDPE has, in case that the polyethylene component (A) consists of 2 ethylene polymer fractions, a ratio of the MFR₂ of the ethylene polymer fraction (A-1) to the MFR₂ of the polyethylene component (A) in the range of 0.10 to 0.85, preferably 0.15 to 0.75.

In another embodiment of the present invention, the metallocene catalysed mMDPE has, a ratio of the MFR₂ of the polyethylene component (A) to the MFR₂ of the final metallocene catalysed mMDPE in the range of 10.0 to 500, preferably of 20.0 to 300, more preferably of 30.0 to 200 and even more preferably 40.0 to 100.

The metallocene catalysed mMDPE may be produced by polymerization using conditions which create a multimodal (e.g. bimodal) polymer product using a metallocene catalyst system.

Thus, the metallocene catalysed mMDPE can be produced in a 2-stage process, preferably comprising a slurry reactor (loop reactor), whereby the slurry (loop) reactor is connected in series to a gas phase reactor (GPR), whereby either polyethylene component (A) or polyethylene component (B) is produced in the loop reactor and the other ethylene polymer component is then produced in GPR in the presence of the first produced ethylene polymer component to produce the metallocene catalysed mMDPE, preferably the polyethylene component (A) is produced in the loop reactor and the polyethylene component (B) is produced in GPR in the presence of the polyethylene component (A) to produce the metallocene catalysed mMDPE.

In case that the polyethylene component (A) of the metallocene catalysed mMDPE consists of ethylene polymer fractions (A-1) and (A-2), the metallocene catalysed mMDPE can be produced with a 3-stage process, preferably comprising a first slurry reactor (loop reactor 1), whereby the first slurry loop reactor is connected in series with another slurry reactor (loop reactor 2), so that the first ethylene polymer fraction (A-1) produced in the loop reactor 1 is fed to the loop reactor 2, wherein the second ethylene polymer fraction (A-2) is produced in the presence of the first fraction (A-1). It is possible that fraction (A-1) is produced first and then fraction (A-2) is produced in the presence of fraction (A-1) in a subsequent reactor or vice versa, i.e. fraction (A-2) is produced first and then fraction (A-1) is produced in the presence of fraction (A-2) in a subsequent reactor. Preferably, fraction (A-1) is produced first.

It is within the scope of the invention, that the first and the second ethylene polymer fraction (A-1 and A-2) of the polyethylene component (A) are present in a weight ratio of 4:1 up to 1:4, such as 3:1 to 1:3, or 2:1 to 1:2, or 1:1, based on the total weight of the polyethylene component (A).

The first and the second polymerization stages of the 3-stage process are preferably slurry polymerization steps.

The slurry polymerization usually takes place in an inert diluent, typically a hydrocarbon diluent such as methane, ethane, propane, n-butane, isobutane, pentanes, hexanes, heptanes, octanes etc., or their mixtures. Preferably, the diluent is a low-boiling hydrocarbon having from 1 to 4 carbon atoms or a mixture of such hydrocarbons. An especially preferred diluent is propane, possibly containing minor amount of methane, ethane and/or butane.

The temperature in each of the first and second polymerization stages is typically from 60 to 100° C., preferably from 70 to 90° C. An excessively high temperature should be avoided to prevent partial dissolution of the polymer into the diluent and the fouling of the reactor. The pressure is from 1 to 150 bar, preferably from 40 to 80 bar.

The slurry polymerization may be conducted in any known reactor used for slurry polymerization. Such reactors include a continuous stirred tank reactor and a loop reactor. It is especially preferred to conduct the slurry polymerization in a loop reactor. In such reactors the slurry is circulated with a high velocity along a closed pipe by using a circulation pump. Loop reactors are generally known in the art and examples are given, for instance, in U.S. Pat. Nos. 4,582,816, 3,405,109, 3,324,093, EP-A-479186 and U.S. Pat. No. 5,391,654. It is thus preferred to conduct the first and second polymerization stages as slurry polymerizations in two consecutive loop reactors.

The slurry may be withdrawn from each reactor either continuously or intermittently. A preferred way of intermittent withdrawal is the use of settling legs where slurry is allowed to concentrate before withdrawing a batch of the concentrated slurry from the reactor. The use of settling legs is disclosed, among others, in U.S. Pat. Nos. 3,374,211, 3,242,150 and EP-A-1310295. Continuous withdrawal is disclosed, among others, in EP-A-891990, EP-A-1415999, EP-A-1591460 and WO-A-2007/025640. The continuous withdrawal is advantageously combined with a suitable concentration method, as disclosed in EP-A-1310295 and EP-A-1591460. It is preferred to withdraw the slurry from each of the first and second polymerization stages continuously.

Hydrogen is typically introduced into the first and second polymerization stages for controlling the MFR₂ of the first and second ethylene polymers. The amount of hydrogen needed to reach the desired MFR depends on the catalyst used and the polymerization conditions.

The last loop reactor is thereby connected in series to a gas phase reactor (GPR), so that the polyethylene component (A) leaving the second slurry reactor is fed to the GPR to produce a trimodal polyethylene copolymer. In this case, the reaction conditions in the two slurry reactors are chosen in a way that in the two slurry reactors different products in view of MFR and/or density are produced.

The third polymerization stage is a gas phase polymerization step, i.e. carried out in a gas-phase reactor. Any suitable gas phase reactor known in the art may be used, such as a fluidised bed gas phase reactor.

For gas phase reactors, the reaction temperature used will generally be in the range 60 to 115° C. (e.g. 70 to 110° C.), the reactor pressure will generally be in the range 10 to 25 bar, and the residence time will generally be 1 to 8 hours. The gas used will commonly be a non-reactive gas such as nitrogen or low boiling point hydrocarbons such as propane together with monomer (e.g. ethylene).

A chain transfer agent (e.g. hydrogen) is typically added to the third polymerization stage.

Such a process is described inter alia in WO 2016/198273, WO 2021009189, WO 2021009190, WO 2021009191 and WO 2021009192. Full details of how to prepare suitable multimodal polymers can be found in these references.

A suitable process is the Borstar PE process or the Borstar PE 3G process.

The metallocene catalysed mMDPE according to the present invention is therefore preferably produced in a loop loop gas cascade. Such polymerization steps may be preceded by a prepolymerization step.

The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step is preferably conducted in slurry. Thus, the prepolymerization step may be conducted in a loop reactor.

The prepolymerization is then preferably conducted in an inert diluent, typically a hydrocarbon diluent such as methane, ethane, propane, n-butane, isobutane, pentanes, hexanes, heptanes, octanes etc., or their mixtures. Preferably, the diluent is a low-boiling hydrocarbon having from 1 to 4 carbon atoms or a mixture of such hydrocarbons.

The temperature in the prepolymerization step is typically from 0 to 90° C., preferably from 20 to 80° C. and more preferably from 45 to 75° C.

The pressure is not critical and is typically from 1 to 150 bar, preferably from 40 to 80 bar.

The amount of monomer is typically such that from 0.1 to 1000 grams of monomer per one gram of solid catalyst component is polymerized in the prepolymerization step. As the person skilled in the art knows, the catalyst particles recovered from a continuous prepolymerization reactor do not all contain the same amount of prepolymer. Instead, each particle has its own characteristic amount, which depends on the residence time of that particle in the prepolymerization reactor. As some particles remain in the reactor for a relatively long time and some for a relatively short time, then also the amount of prepolymer on different particles is different and some individual particles may contain an amount of prepolymer which is outside the above limits. However, the average amount of prepolymer on the catalyst typically is within the limits specified above.

The molecular weight of the prepolymer may be controlled by hydrogen as it is known in the art. Further, antistatic additives may be used to prevent the particles from adhering to each other or the walls of the reactor, as disclosed in WO-A-96/19503 and WO-A-96/32420.

The catalyst components are preferably all introduced to the prepolymerization step when a prepolymerization step is present. However, where the solid catalyst component and the cocatalyst can be fed separately it is possible that only a part of the cocatalyst is introduced into the prepolymerization stage and the remaining part into subsequent polymerization stages. Also in such cases it is necessary to introduce so much cocatalyst into the prepolymerization stage that a sufficient polymerization reaction is obtained therein.

It is understood within the scope of the invention, that the amount or polymer produced in the prepolymerization lies within 1.0 to 5.0 wt % in respect to the final metallocene catalysed mMDPE. This can counted as part of the first polyethylene component (A).

### Catalyst

The metallocene catalysed mMDPE of the invention is one made using a metallocene catalyst. A metallocene catalyst comprises a metallocene complex and a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

In an embodiment, the organometallic compound (C) has the following formula (I):

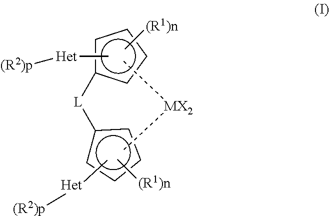

wherein each X is independently a halogen atom, a C₁₋₆-alkyl group, C₁₋₆-alkoxy group, phenyl or benzyl group;

each Het is independently a monocyclic heteroaromatic group containing at least one heteroatom selected from O or S;

L is —R′₂Si—, wherein each R′ is independently C₁₋₂₀-hydrocarbyl or C₁₋₁₀-alkyl substituted with alkoxy having 1 to 10 carbon atoms;

M is Ti, Zr or Hf;

each R¹ is the same or different and is a C₁₋₆-alkyl group or C₁₋₆-alkoxy group;

each n is 1 to 2;

each R² is the same or different and is a C₁₋₆-alkyl group, C₁₋₆-alkoxy group or —Si(R)₃ group;

each R is C₁₋₁₀-alkyl or phenyl group optionally substituted by 1 to 3 C₁₋₆-alkyl groups; and

each p is 0 to 1.

Preferably, the compound of formula (I) has the structure

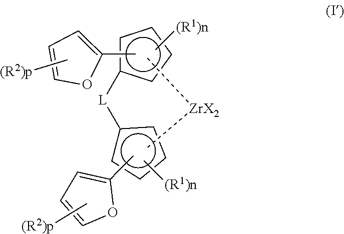

wherein each X is independently a halogen atom, a C₁₋₆-alkyl group, C₁₋₆-alkoxy group, phenyl or benzyl group;

L is a Me₂Si—;

each R¹ is the same or different and is a C₁₋₆-alkyl group, e.g. methyl or t-Bu;

each n is 1 to 2;

R² is a —Si(R)₃ alkyl group; each p is 1;

each R is C₁₋₆-alkyl or phenyl group.

Highly preferred complexes of formula (I) are

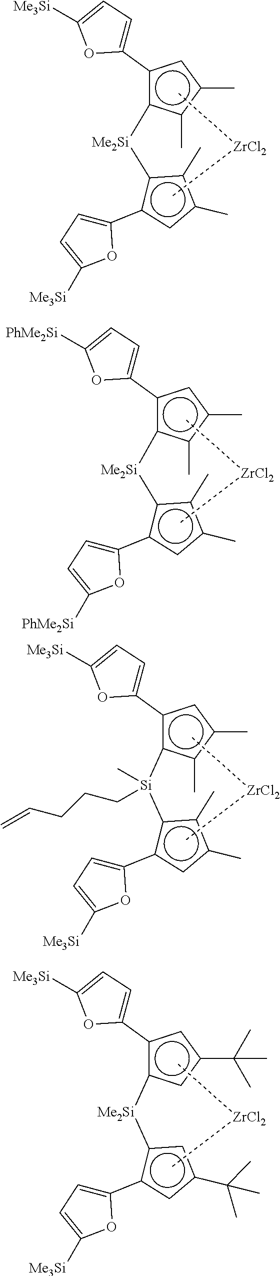

Most preferably the complex dimethylsilanediylbis[2-(5-trimethylsilylfuran-2-yl)-4,5-dimethylcyclopentadien-1-yl]zirconium dichloride is used.

More preferably the polyethylene components (A) and (B) of the metallocene catalysed mMDPE are produced using, i.e. in the presence of, the same metallocene catalyst.

To form a catalyst, a cocatalyst, also known as an activator, is used, as is well known in the art. Cocatalysts comprising Al or B are well known and can be used here. The use of aluminoxanes (e.g. MAO) or boron based cocatalysts (such as borates) is preferred. Polyethylene copolymers made using single site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

The metallocene catalysed mMDPE may contain additives and/or fillers.

The optional additives and fillers and the used amounts thereof are conventional in the field of film applications. Examples of such additives are, among others, antioxidants, UV-stabilizers, pigments, fillers, antistatic additives, antiblock agents, nucleating agents, acid scavengers as well as polymer processing agent (PPA).

In one embodiment of the present invention, the metallocene catalysed mMDPE is free of fluoro-based polymer processing agents (PPAs).

In this embodiment, the metallocene catalysed mMDPE of the present invention is blended with 0.1 to 3.0 wt %, based on the total weight of the blend, of a polyethylene wax.

In this embodiment, the polyethylene wax is added instead of a fluoro-based polymer processing agent.

The amount of added polyethylene wax is preferably in the range of 0.5 to 2.8 wt %, more preferably 0.8 to 2.6 wt % and even more preferably 1.0 to 2.5 wt %, based on the total weight of the blend of wax and mMDPE.

The polyethylene wax in the present invention refers to a homopolymer of ethylene, a copolymer of ethylene and an α-olefin, or a blended product thereof.

The polyethylene wax may have a weight-average molecular weight (determined via a viscometric method) of 1000 to 20000 g/mol, preferably 1500 to 15000 and more preferably 2000 to 10000.

The polyethylene wax may be a high-density polyethylene wax with a density 960 kg/m³ or more, a medium-density polyethylene wax with a density ranging from 940 to 950 kg/m³ or a low-density polyethylene wax with a density of 930 kg/m³ or less. Preferably, a low-density polyethylene wax with a density in the range of 900 to 930 kg/m³ is used.

Density is measured in accordance with JIS K6760 or ISO 1183 (dependent on the producer of the wax).

Suitable polyethylene waxes may have a melt viscosity measured at 140° C. in the range of from 15 to 10 000 mPa·s, preferably in the range of 20 to 8 000 mPa·s, more preferably in the range of 50 to 7 000 mPa·s and even more preferably in the range of 60 to 6 500 mPa·s. Melt viscosity can be measured according to DIN 53019.

The polyethylene waxes may alternatively or in addition be characterized by a drop point measured according to ASTM 3954 in the range of 115 to 140° C., preferably 118 to 135° C. and more preferably 120 to 132° C. and/or a softening point measured according to JIS K 2207 in the range of 90 to 140° C., preferably 92 to 135° C., more preferably 95 to 130° C. and yet more preferably 98 to 125°.

The polyethylene wax may be prepared by using a Ziegler-Natta catalyst or by using a metallocene catalyst.

Such polyethylene waxes are commercially available.

Specific examples of the commercially available polyethylene wax include the Hi-WAX serie and the Excerex serie from Mitsui Chemicals or the Licowax PE family and the Licocene PE family from Clarinat.

As mentioned above, the metallocene catalysed mMDPE or the blend with a polyethylene wax according to the present invention provides improved mechanical properties, especially tensile modulus and dart drop (impact strength).

The invention is therefore further directed to a film comprising at least one layer comprising the above described metallocene catalysed mMDPE or the blend with polyethylene wax.

### Film

The film of the invention comprises at least one layer comprising the above defined metallocene catalysed mMDPE (respectively blend with polyethylene wax). The film can be a monolayer film comprising the above defined polyethylene composition or a multilayer film, wherein at least one layer comprises the above defined polyethylene composition. The terms “monolayer film” and multilayer film” have well known meanings in the art. Preferably, the at least one layer of the invention comprises at least 50 wt %, more preferably at least 60 wt %, even more preferably at least 70 wt %, yet more preferably at least 80 wt %, of the metallocene catalysed mMDPE (respectively blend with polyethylene wax) of the invention. Most preferably said at least one layer of the film of invention consists of the metallocene catalysed mMDPE (respectively blend with polyethylene wax).

The films are preferably produced by any conventional film extrusion procedure known in the art including cast film and blown film extrusion. Most preferably, the film is a blown or cast film, especially a blown film. E.g. the blown film is produced by extrusion through an annular die and blowing into a tubular film by forming a bubble which is collapsed between nip rollers after solidification. This film can then be slit, cut or converted (e.g. gusseted) as desired. Conventional film production techniques may be used in this regard. If the preferable blown or cast film is a multilayer film then the various layers are typically coextruded. The skilled man will be aware of suitable extrusion conditions.

Films according to the present invention may be subjected to post-treatment processes, e.g. surface modifications, lamination or orientation processes or the like. Such orientation processes can be mono-axially (MDO) or bi-axially orientation, wherein mono-axial orientation is preferred.

In another preferred embodiment, the films are unoriented.

Preferred films according to the invention are monolayer blown films.

The monolayer film of the invention may have a thickness of 20 to 120 um, preferably 30 to 100 um and more preferably 35 to 80 um.

The films according to the present invention have the below described properties:
a) The films of the invention have a dart-drop impact strength (DDI) determined according to ISO 7765-1:1988 on a 40 um monolayer test blown film of at least 700 g up to 2000 g, preferably 800 g up to 1500 g and more preferably 850 g up to 1100 g, and
b) Films according to the present invention have good stiffness (tensile modulus measured on a 40 μm monolayer test blown film according to ISO 527-3), i.e. >250 MPa (in both directions). Thus, the films according to the present invention have a tensile modulus (measured on a 40 μm monolayer test blown film according to ISO 527-3) in machine (MD) direction in the range of >250 MPa to 1000 MPa, preferably of 300 MPa to 600 MPa and in transverse (TD) direction in the range of 300 MPa to 1000 MPa, preferably of 350 MPa to 600 MPa.

The films according to the present invention are highly useful for being used in various packaging applications.

Furthermore the films according to the present invention may be used as a layer in multilayer polyethylene based blown film, preferably as core layer in multilayer polyethylene based blown films.

The invention will be further described with reference to the following non-limiting examples.

### Determination Methods

Unless otherwise stated in the description or in the experimental part, the following methods were used for the property determinations of the polymers (including its fractions and components) and/or any sample preparations thereof as specified in the text or experimental part.

### Melt Flow Rate

The melt flow rate (MFR) was determined according to ISO 1133 and is indicated in g/10 min. The MFR is an indication of the flowability, and hence the processability, of the polymer. The MFR is determined at 190° C. for polyethylene. MFR may be determined at different loadings such as 2.16 kg (MFR₂), 5 kg (MFR5) or 21.6 kg (MFR₂₁).

### Calculation of MFR₂ of Component B and of Fraction (A-2)

$$log A = x \cdot log B + ( 1 - x ) \cdot log C \\ C = 10 {\hat{}}^{\frac{( log A - x \cdot log B )}{( 1 - x )}}$$

### For Component B

B=MFR₂ of Component (A)
C=MFR₂ of Component (B)
A=final MFR₂ (mixture) of multimodal mMDPE
X=weight fraction of Component (A).

### For Fraction (A-2)

B=MFR₂ of 1^{st} fraction (A-1)
C=MFR₂ of 2^{nd} fraction (A-2)
A=final MFR₂ (mixture) of loop polymer (=Component (A))
X=weight fraction of the 1^{st} fraction (A-1).

### Density

Density of the polymer was measured according to ISO 1183 and ISO1872-2 for sample preparation and is given in kg/m³.

### GPC

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{z} = \frac{{\sum }_{i = 1}^{N} ( {A}_{i} \times {M}_{i}^{2} )}{{\sum }_{i = 1}^{N} ( {A}_{i} \times {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain), equipped with 3× Agilent-PLgel Olexis and 1× Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration (according to ISO 16014-2:2003) with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

$${K}_{PS} = 19 \times {10}^{- 3} mL \text{/g} , {α}_{PS} = 0.655 \\ {K}_{PE} = 39 \times {10}^{- 3} mL \text{/g} , {α}_{PE} = 0 \text{.725} \\ {K}_{PP} = 19 \times {10}^{- 3} mL \text{/g} , {α}_{PP} = 0.725$$

A third order polynomial fit was used to fit the calibration data.

All samples were prepared in the concentration range of 0.5-1 mg/ml and dissolved at 160° C. for 2.5 hours for PP or 3 hours for PE under continuous gentle shaking.

To exclude the influence of additives like irganox 1010, irgafos 168 or some other low molecular weight oligomers, the low molecular weight integration limit was set in the valley between the antioxidant peak and the polymer peak (˜log M of 2.8 (PE equivalent) for the analysed samples).

### Dart Drop Strength (DDI): Impact Resistance by Free-Falling Dart Method

The DDI was measured according to ISO 7765-1:1988/Method A from the films (non-oriented films and laminates) as produced indicated below. This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions

Conditioning time: >96 h at 50±2° C.±10% rh
Test temperature: 23° C.
Dart head material: phenolic
Dart diameter: 38 mm
Drop height: 660 mm

### Results

Impact failure weight—50% [g]

### Tensile Modulus

The tensile test was conducted according to ISO 527-3, moreover the modulus of elasticity (secant modulus between 0.05% and 0.25% elongation) is also determined. Type 2 (parallel-sided specimens) specimens were used.

During testing a specimen is extended along its major axis for determination of tensile properties at constant testspeed (speed of crosshead) until the specimen fracture. During this procedure the load sustained by the specimen and the elongation, which is measured by the crosshead, are measured.

### Standard Conditions

Conditioning time: >96 h at 50±2° C.±10% rh
Test temperature: 23° C.
Gripping distance: 100 mm
Gauge length: 100 mm
Secant modulus: 0.05%-0.25%
Testspeed modulus: 1 mm/min
Testspeed: 200 mm/min

### Film Sample Preparation

The film samples have been produced using a W&H semi-commercial line. Film with 40 μm thickness were produced with BUR 1:3. Melt temperature ˜222° C. and frost line distance 700 mm, screw speed 126 rpm and take off speed 18.8 m/min.

### EXAMPLES

### Cat.Example: Catalyst Preparation for CAT1 for Inventive Examples IE1 and IE2 and Comparative Example CE1 and CE2

### Loading of SiO2

10 kg of silica (PQ Corporation ES757, calcined 600° C.) was added from a feeding drum and inertized in the reactor until O₂ level below 2 ppm was reached.

### Preparation of MAO/tol/MC

30 wt % MAO in toluene (14.1 kg) was added into another reactor from a balance followed by toluene (4.0 kg) at 25° C. (oil circulation temp) and stirring 95 rpm. Stirring speed was increased 95 rpm→200 rpm after toluene addition, stirring time 30 min. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst

Reactor temperature was set to 10° C. (oil circulation temp) and stirring was turned to 40 rpm during MAO/tol/MC addition. MAO/tol/MC solution (22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Cat.Example: Catalyst Preparation for CAT2 for CE3

ZN catalyst prepared according to Example 1 of EP 1378528: Catalyst was used together with triethylaluminium cocatalyst so that the molar ratio of Al/Ti was about 15.

### Polymerization

Borstar pilot plant with a 3-reactor set-up (loop1-loop2-GPR 1) and a prepolymerization loop reactor.

TABLE 1
Polymerization conditions for IE1, IE2, CE1 to CE3

| | IE1 | IE2 | CE1 | CE2 | CE3 |
|---|---|---|---|---|---|
| Catalyst | CAT1 | CAT1 | CAT2 | CAT1 | CAT2 |
| Prepoly reactor | | | | | |
| Temp. (° C.) | 50 | 50 | 50 | 50 | 70 |
| Press. (kPa) | 5882 | 5749 | 5696 | 5716 | 6300 |
| C2 (kg/h) | 4.0 | 4.0 | 4.0 | 4.0 | 2.0 |
| H2(g/h) | 0.0 | 0.0 | 0.0 | 0.03 | 5.0 |
| C4 (g/h) | 75.0 | 99.8 | 85.1 | 97.4 | 80.0 |
| Split (wt %) | 3.7 | 3.6 | 4.1 | 6.1 | 1.0 |
| loop 1 Fraction (A-1) | | | | | |
| Temp. (° C.) | 85 | 85 | 85 | 85 | 85 |
| Press. (kPa) | 5443 | 5461 | 5218 | 5234 | 6100 |
| C2 conc. (mol %) | 4.4 | 3.7 | 3.9 | 4.0 | 4.0 |
| H2/C2 ratio (mol/kmol) | 0.48 | 0.47 | 0.43 | 0.29 | 217.0 |
| C4/C2 ratio (mol/kmol) | 3.5 | 5.3 | 34.6 | 49.9 | 443.0 |
| Split (wt %) | 19.3 | 21.4 | 20.6 | 41.7 | 21.0 |
| Density (kg/m3) of loop 1 | 958.8 | 954.4 | 940.8 | 942.0 | 950.0 |
| material (fraction (A-1) | | | | | |
| MFR2 (g/10 min) of loop 1 | 21.8 | 11.0 | 5.3 | 4.3 | 280.0 |
| material (fraction (A-1) | | | | | |
| loop 2 | | | | | |
| Temp. (° C.) | 85 | 85 | 85 | 85 | 85 |
| Press. (kPa) | 5389 | 5290 | 5332 | 5355 | 5400 |
| C2 conc. (mol %) | 4.3 | 4.9 | 4.3 | 3.6 | 3.5 |
| H2/C2 ratio (mol/kmol) | 0.3 | 1.6 | 0.4 | 0.3 | 280.0 |
| C4/C2 ratio (mol/kmol) | 1.0 | 2.0 | 30.0 | 62 | 622.0 |
| Split (wt %) | 21.9 | 22.5 | 24.3 | 52.3 | 21.0 |
| Density (kg/m3) after loop 2 | 962.0 | 966.4 | 938.2 | 928.5 | 950.0 |
| (component (A)) | | | | | |
| MFR2 (g/10 min) after loop 2 | 31.2 | 65.0 | 5.0 | 0.5 | 300.0 |
| (component (A)) | | | | | |
| MFR2 (g/10 min) of loop 2 | 45 | 465 | 4.7 | 0.069 | 322 |
| material (fraction (A-2)) | | | | | |
| Density (kg/m3) of loop 2 | 965 | 979 | 936 | 954 | 950 |
| material (fraction (A-2)) | | | | | |
| GPR | | | | Not in use | |
| Temp. (° C.) | 75 | 75 | 75 | | 80 |
| Press. (kPa) | 2000 | 2000 | 2000 | | 2000 |
| H2/C2 ratio (mol/kmol) | 0.51 | 0.62 | 0.68 | | 6.89 |
| C6/C2 ratio (mol/kmol) | 9.14 | 0 | 8.12 | | 0 |
| C4/C2 ratio (mol/kmol) | 0 | 0 | 0 | | 693 |
| Split (wt %) | 55.1 | 51.1 | 51.0 | | 57.0 |
| MFR2 (g/10 min) of GPR | 0.018 | 0.007 | 0.06 | | 0.004 |
| material (Component (B)) | | | | | |
| Density (kg/m3) of GPR | 901 | 890 | 918 | | 904 |
| material (Component (B)) | | | | | |

The polymers were mixed with 0.027 wt % FX 5922 (3M Dynamar Polymer Processing Additive), 0.05 wt % Irganox 1010 FF (BASF) and 0.20 wt % Irgafos 168 FF (BASF), where wt % are relative to total weight of composition (the sum of mMDPE powder+additive=100%) compounded and extruded on a ZSK 57 twin screw extruder. The melt temperature was 224° C., production rate was 221 kg/h.

For Inventive Example 3, IE3 the base polymer IE2 of Table 1 was compounded with 0.05 wt % Irganox 1010 FF (BASF), 0.20 wt % Irgafos 168 FF (BASF) and 2.0 wt % of Excerex 40800 (Mitsui) as PPA, instead of FX 5922, where wt % are relative to total weight of composition (the sum of mMDPE powder+additive=100%)

TABLE 2
Material properties

| Material | IE1 | IE2 | IE3 | CE1 | CE2 | CE3 |
|---|---|---|---|---|---|---|
| MFR₂ (g/10 min) (final) | 0.6 | 0.6 | 0.6 | 0.5 | 0.7 | 0.5 |
| MFR₂₁ (g/10 min) | 26.3 | 33.6 | 35.9 | 17.9 | 17.9 | 40.0 |
| MFR₂₁/MFR₂ (FRR) | 43.1 | 59.9 | 56.2 | 35.8 | 25.6 | 80.0 |
| Density (kg/m³) (final) | 928.4 | 927.3 | 927.8 | 924.8 | 930.9 | 924.0 |
| Mz (g/mol) | 291000 | 289000 | 293000 | n.m. | n.m. | 672500 |
| Mw (g/mol) | 110000 | 105000 | 105000 | n.m. | n.m. | 141500 |
| Mn (g/mol) | 24600 | 14800 | 14000 | n.m. | n.m. | 11350 |
| Mz/Mw | 2.65 | 2.75 | 2.79 | — | — | 4.75 |
| Mw/Mn (MWD) | 4.47 | 7.09 | 7.50 | — | — | 12.47 |
| MFR(A-1)/MFR(A) | 0.7 | 0.2 | 0.2 | 1.1 | 8.6 | 0.9 |
| MFR(A)/MFR(final) | 52.0 | 95.6 | 95.6 | 9.4 | 0.7 | 600 |
| density(A)-density(final) | 34.2 | 39.9 | 39.4 | 13.8 | n.a. | 26.0 |

n.m. not measured
n.a. not applicable

### Monolayer Blown Films

TABLE 3
Properties of blown films

| | | IE1 | IE2 | IE3 | CE1 | CE2 | CE3 |
|---|---|---|---|---|---|---|---|
| TM/MD | MPa | 359 | 356 | 358 | 235 | 344 | 316 |
| TM/TD | MPa | 409 | 384 | 429 | 245 | 354 | 407 |
| DDI | g | 949 | 1055 | 865 | 668 | 99 | 180 |

As can be seen from the above Table 3 films based on the compositions using the metallocene catalysed mMDPEs according to the present invention have improved stiffness and/or impact properties.

Even IE3, based on a metallocene catalysed mMDPEs according to the present invention and using a polyethylene wax as PPA, instead of a fluoro-containing PPA, has improved stiffness and/or impact properties.

1.-16. (canceled)

17. A metallocene catalysed multimodal medium density polyethylene (mMDPE), which consists of:
(i) 35.0 to 55.0 wt %, based on the mMDPE, of a polyethylene component (A); and
(ii) 45.0 to 65.0 wt %, based on the mMDPE, of a polyethylene component (B);
whereby the polyethylene polymer component (A) has:
a density (ISO 1183) in a range of from 930 to 975 kg/m³, and
a MFR₂ (190° C., 2.16 kg, ISO 1133) in a range of from 10.0 to 200.0 g/10 min;
the polyethylene component (B) has:
a density (ISO 1183) in a range of from 870 to 910 kg/m³, and
a MFR₂ (190° C., 2.16 kg, ISO 1133) in a range of from 0.0001 to 0.5 g/10 min;
whereby the metallocene catalysed medium density polyethylene (mMDPE) has:
a density (ISO 1183) in a range of from 915 to 945 kg/m³,
a MFR₂ (190° C., 2.16 kg, ISO 1133) in a range of from 0.1 to 2.0 g/10 min, and:
a ratio of MFR₂₁ (190° C., 21.6 kg, ISO 1133) to MFR₂ (190°° C., 2.16 kg, ISO 1133), MFR₂₁/MFR₂, in a range of from 37 to 75; and
wherein a difference in density of the polyethylene component (A) to the density of the final metallocene catalysed mMDPE (Δ density: density of polyethylene component (A)−density of final metallocene catalysed mMDPE) is in a range of 28 to 70 kg/m³.

18. The metallocene catalysed multimodal medium density polyethylene (mMDPE), according to claim 17, wherein the metallocene catalysed mMDPE has at least one, and/or two and and/or all of properties a)-d);
a) a density (ISO1183) in a range of 918 to 940 kg/m³, and/or 920 to 935 kg/m³;
b) a MFR₂ (190° C., 2.16 kg, ISO 1133) in a range of 0.2 to 1.8 g/10 min, and/or 0.3 to 1.5 g/10 min, and/or 0.4 to 1.0 g/10 min;
c) a MFR₂₁ (190° C., 21.6 kg, ISO 1133) in a range of 10.0 to 80.0 g/10 min, and/or in a range of 15.0 to 70.0 g/10 min, and/or in a range of 20.0 to 60.0 g/10 min, and/or 22.0 to 50.0 g/10 min; and
d) a Flow Rate Ratio (FRR), MFR₂₁/MFR₂ in a range of 40 to 70, and/or of 42 to 65.

19. The metallocene catalysed multimodal medium density polyethylene (mMDPE) according to claim 17, wherein the metallocene catalysed mMDPE has:
a molecular weight distribution (MWD), Mw/Mn, measured with GPC as described in the experimental part, in a range of 3.5 to 12.0, and/or 4.0 to 10.0, and/or 4.2 to 8.0.

20. The metallocene catalysed multimodal medium density polyethylene (mMDPE) according to claim 17, wherein the metallocene catalysed mMDPE has in addition at least one or more or all of the following properties:
a weight average molecular weight, Mw, of at least 90000 g/mol, in the range of from 92000 to 140000 g/mol, and/or from 95000 to 130000 g/mol, and/or from 100000 to 120000 g/mol;
a z average molecular weight, Mz, in a range of 200000 to 500000 g/mol, and/or 230000 to 400000 g/mol, and/or from 250000 to 350000 g/mol; and
a ratio of Mz/Mw be in a range of 2.0 to 4.0, and/or 2.2 to 3.5, and/or 2.3 to 3.2, wherein Mw and Mz are measured with GPC as described in the experimental part.

21. The metallocene catalysed multimodal medium density polyethylene (mMDPE) according to claim 17, wherein in the metallocene catalysed mMDPE, the polyethylene component (A) has:
a density (ISO1183) in a range of 935 to 972 kg/m³, and/or 940 to 970 kg/m³, and/or 945 to 968 kg/m³, and/or 950 to 968 kg/m³, and/or 955 to 968 kg/m³; and
a MFR₂ (190° C., 2.16 kg, ISO 1133) in a range of 15.0 to 150 g/10 min, and/or 20.0 to 100 g/10 min, and/or 22.0 to 90.0 g/10 min, and
the polyethylene component (B) has:
a density (ISO1183) in a range of 875 to 908 kg/m³, and/or 880 to 906 kg/m³, and/or 885 to 904 kg/m³; and
a MFR₂ (190° C., 2.16 kg, ISO 1133) in a range of 0.001 to 0.1 g/10 min, and/or 0.003 to 0.08 g/10 min, and/or 0.005 to 0.05 g/10 min.

22. The metallocene catalysed multimodal medium density polyethylene (mMDPE) according to claim 17, wherein in the metallocene catalysed mMDPE, polyethylene component (A) and/or (B) is a homopolymer or an ethylene copolymer, and/or
both components (A) and (B) are an ethylene copolymer; or
alternatively polyethylene component (A) is a homopolymer and polyethylene component (B) is a copolymer or vice versa, and/or
polyethylene component (A) being a copolymer and polyethylene component (B) being a homopolymer, and/or
polyethylene component (A) is an ethylene-1-butene copolymer and polyethylene component (B) is either an ethylene-1-hexene copolymer or a homopolymer.

23. The metallocene catalysed multimodal medium density polyethylene (mMDPE) according to claim 17, wherein in the metallocene catalysed mMDPE, polyethylene component (B) consists of:
a single ethylene copolymer or of a single ethylene homopolymer; and
polyethylene component (A) consists of:
a single ethylene homo-or copolymer or alternatively, polyethylene component (A) is an ethylene homo-or copolymer mixture comprising, and/or consisting of:
a first ethylene polymer fraction (A-1) and a second ethylene polymer fraction (A-2), whereby both fractions are either a homopolymer or a copolymer.

24. The metallocene catalysed multimodal medium density polyethylene (mMDPE) according to claim 23, wherein the polyethylene component (A) is a polyethylene copolymer mixture comprising, and/or consisting of:
a first ethylene copolymer fraction (A-1) and a second ethylene copolymer fraction (A-2);
whereby the ethylene polymer fraction (A-1) has:
a MFR₂ (190° C., 2.16 kg, ISO 1133) in a range of 3.0 to 80.0 g/10 min, and/or of 5.0 to 60.0 g/10 min, and/or of 8.0 to 40.0 g/10 min, and/or of 10.0 to 30.0 g/10 min, and a density (ISO1183) in a range of 930 to 970 kg/m³, and/or 940 to 965 kg/m³, and/or 950 to 960 kg/m³; and
the ethylene polymer fraction (A-2) has:
a MFR₂ (190° C., 2.16 kg, ISO 1133) in a range of 10.0 to 1000 g/10 min, and/or of 20.0 to 800 g/10 min, and/or of 30.0 to 700 g/10 min, and/or of 35.0 to 600 g/10 min, and/or of 40.0 to 500 g/10 min, and
a density (ISO1183) in a range of 930 to 980 kg/m³, and/or 940 to 980 kg/m³, and/or 950 to 979 kg/m³.

25. The metallocene catalysed multimodal medium density polyethylene (mMDPE) according to claim 24, wherein the MFR₂ of the ethylene polymer fraction (A-1) to the MFR₂ of the polyethylene component (A) is in a range of 0.10 to 0.85, and/or 0.15 to 0.75.

26. The metallocene catalysed multimodal medium density polyethylene (mMDPE) according to claim 17, wherein a ratio of the MFR₂ of the polyethylene component (A) to the MFR₂ of the final metallocene catalysed mMDPE is in a range of 10.0 to 500, and/or of 20.0 to 300, and/or of 30.0 to 200, and/or 40.0 to 100.

27. The metallocene catalysed multimodal medium density polyethylene (mMDPE) according to claim 17, wherein a difference in density of the polyethylene component (A) to a density of the final metallocene catalysed mMDPE (A density: density of polyethylene component (A)-density of final metallocene catalysed mMDPE) is in a range 30 to 55 kg/m³, and/or 32 to 45 kg/m³.

28. The metallocene catalysed multimodal medium density polyethylene (mMDPE) according to claim 17, wherein the mMDPE is a product of a presence of metallocene complex of formula (I): 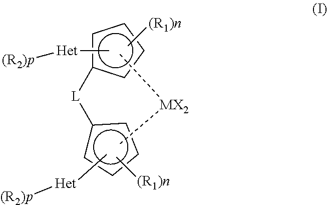
wherein each X is independently a halogen atom, a C₁₋₆-alkyl group, C₁₋₆-alkoxy group, phenyl or benzyl group;
each Het is independently a monocyclic heteroaromatic group containing at least one heteroatom selected from O or S;
L is —R′₂Si—, wherein each R′ is independently C₁₋₂₀-hydrocarbyl or C₁₋₁₀-alkyl substituted with alkoxy having 1 to 10 carbon atoms;
M is Ti, Zr or Hf;
each R₁ is a same or different and is a C₁₋₆-alkyl group or C₁₋₆-alkoxy group;
each n is 1 to 2;
each R₂ is a same or different and is a C₁₋₆-alkyl group, C₁₋₆-alkoxy group or —Si(R)₃ group;
each R is C₁₋₁₀-alkyl or phenyl group optionally substituted by 1 to 3 C₁₋₆-alkyl groups; and
each p is 0 to 1.

29. The metallocene catalysed multimodal medium density polyethylene (mMDPE) according to claim 17, wherein the mMDPE is blended with 0.1 to 3.0 wt %, based on a total weight of the blend, of a polyethylene wax.

30. A film comprising:
the metallocene catalysed multimodal medium density polyethylene (mMDPE) according to claim 17.

31. The film according to claim 30, wherein the film has:
a) a dart-drop impact strength (DDI) determined according to ISO 7765-1:1988 on a 40 μm monolayer test blown film of at least 700 g up to 2000 g, and/or 800 g up to 1500 g, and/or 850 g up to 1100 g, and
b) a tensile modulus (measured on a 40 μm monolayer test blown film according to ISO 527-3) in machine (MD) direction in a range of >250 MPa to 1000 MPa, and/or of 300 MPa to 600 MPa, and in transverse (TD) direction in a range of 300 MPa to 1000 MPa, and/or of 350 MPa to 600 MPa.

32. The film according to claim 30 in combination with a packaging application, or with a multilayer polyethylene based blown film, as a core layer in the multilayer polyethylene based blown film.
